(19) United States
(12) Patent Application Publication
(10) Pub. No.: US 2026/0246322 A1
(43) Pub. Date: Aug. 20, 2026

(54) MODULAR VARIABLE POLE ELECTRIC MOTOR SYSTEM

(71) Applicant: GM GLOBAL TECHNOLOGY OPERATIONS LLC, Detroit, MI (US)

(72) Inventors: Alireza Fatemi, Canton, MI (US); Thomas W. Nehl, Shelby Twp., MI (US); Peng Peng, Rochester Hills, MI (US)

(73) Assignee: GM GLOBAL TECHNOLOGY OPERATIONS LLC, Detroit, MI (US)

(21) Appl. No.: 19/056,853

(22) Filed: Feb. 19, 2025

(51) Int. Cl. H02K 1/22; B60L 15/20; B60L 50/51; H02K 1/16; H02K 3/02; H02K 11/33; H02K 21/04; H02P 25/20

(52) U.S. Cl. CPC H02K 1/223; B60L 15/20; B60L 50/51; H02K 1/16; H02K 3/02; H02K 11/33; H02K 21/04; H02P 25/20; B60L 2240/421

(57) ABSTRACT

A modular variable pole electric motor system includes a stator, a plurality of modular rotors, and an inverter system. The stator includes a plurality of stator coils. The plurality of modular rotors include at least one modular wound field rotor, at least one modular induction rotor, at least one modular permanent magnet rotor, and at least one modular synchronous reluctance rotor. Each of the plurality of modular rotors is configured to be removably electrically coupled to the stator. The inverter system includes a plurality of switches, is electrically coupled to the plurality of stator coils of the stator, and is configured to be electrically coupled to a battery system and convert a direct current (DC) voltage from the battery system into alternating current (AC) to individually energize each of the plurality of stator coils of the stator.

### INTRODUCTION

The technical field generally relates to vehicles, and more particularly relates to a modular variable pole electric motor system.

Electric vehicles (EV) and/or hybrid vehicles typically include a battery system, an inverter system, and an electric motor. The inverter system includes a plurality of switches and is electrically coupled to the electric motor and the battery system. The electric motor typically includes a stator that is compatible with a specific type of rotor and has a fixed number of poles. A controller controls routing of current from the battery system to the electric motor via the inverter system.

Accordingly, it is desirable to provide a modular variable pole electric motor system. Other desirable features and characteristics will become apparent from the subsequent detailed description and the appended claims, taken in conjunction with the accompanying drawings and the foregoing technical field and background.

### SUMMARY

A modular variable pole electric motor system includes: a stator includes a plurality of stator coils; a plurality of modular rotors including at least one modular wound field rotor, at least one modular induction rotor, at least one modular permanent magnet rotor, and at least one modular synchronous reluctance rotor, wherein each of the plurality of modular rotors is configured to be removably electrically coupled to the stator; and an inverter system, wherein the inverter system: includes a plurality of switches; is electrically coupled to the plurality of stator coils of the stator; and is configured to be electrically coupled to a battery system and convert a direct current (DC) voltage from the battery system into alternating current (AC) to individually energize each of the plurality of stator coils of the stator.

In at least one embodiment, the at least one modular induction rotor includes a first modular induction rotor including a copper induction cage and a second modular induction rotor including an aluminum induction cage.

In at least one embodiment, the at least one modular wound field rotor includes a first modular wound field rotor including separately excited windings that are alternate tooth wound and a second modular wound field rotor including separately excited windings that are all tooth wound.

In at least one embodiment, the at least one modular permanent magnet rotor includes a first modular permanent magnet rotor including high energy magnets, a second modular permanent magnet rotor including low energy magnets, and a third modular permanent magnet rotor including a combination of high energy magnets and low energy magnets.

In at least one embodiment, the at least one modular synchronous reluctance rotor includes a first modular synchronous reluctance rotor including a first flux barrier with three layers of rotor cavities, a second modular synchronous reluctance rotor including a second flux barrier with four layers of rotor cavities, and a third modular synchronous reluctance rotor including a third flux barrier with five layers of rotor cavities.

In at least one embodiment, a variable pole controller electrically coupled to the inverter system, wherein: the variable pole controller is configured to implement pole-phase number modulation to define a first number of stator poles of the stator based on a manipulation of the plurality of switches of the inverter system to generate a first phase shift angle of the AC between adjacent stator coils of the plurality of stator coils of the stator and a second number of stator poles of the stator based on a manipulation of the plurality of switches of the inverter system to generate a second phase shift angle of the AC between the adjacent stator coils of the plurality of stator coils of the stator; the first phase shift angle is less than the second phase shift angle; the first number of stator poles is less that the second number of stator poles; the second number of stator poles is a multiple of the first number of stator poles; a first number of phases of the AC applied to the plurality of stator coils of the stator is based on the first phase shift angle; a second number of phases of the AC applied to the plurality of stator coils of the stator is based on the second phase shift angle; and the first number of phases is a multiple of the second number of phases.

In at least one embodiment, a first product of the first number of stator poles and the first number of phases of the AC applied to the plurality of stator coils is equal to a second product of the second number of stator poles and the second number of phases of the AC applied to the plurality of stator coils.

In at least one embodiment, the stator includes 2 to 4 stator slots per stator pole per phase, with a number of poles changing from 4 or 6 to 8 or 12.

In at least one embodiment, a variable pole controller electrically coupled to the inverter system, wherein: the variable pole controller is configured to implement pole-phase sequence modulation to define a third number of stator poles of the stator based on a manipulation of the plurality of switches of the inverter system to generate a fixed number of phases of the AC applied to the plurality of stator coils of the stator in a first sequence wherein each of the fixed number of phases have a first polarity and to define a fourth number of the stator poles based on a manipulation of the plurality of switches of the inverter system to generate the fixed number of phases of the AC applied to the plurality of stator coils of the stator in a second sequence wherein a first subsequence in the second sequence as the first polarity and a second subsequence in the second sequence has a second polarity that is opposite the first polarity; and the third number of stator poles is twice the fourth number of stator poles.

In at least one embodiment, the stator includes 2 to 4 stator slots per stator pole per phase, with a number of poles changing from 4 or 6 to 8 or 12.

A vehicle including a modular variable pole electric motor system includes: a stator including a plurality of stator coils; a plurality of modular rotors including at least one modular wound field rotor, at least one modular induction rotor, at least one modular permanent magnet rotor, and at least one modular synchronous reluctance rotor, wherein each of the plurality of modular rotors is configured to be removably electrically coupled to the stator; and an inverter system, wherein the inverter system: includes a plurality of switches; is electrically coupled to the plurality of stator coils of the stator; and is configured to be electrically coupled to a battery system and convert a direct current (DC) voltage from the battery system into alternating current (AC) to individually energize each of the plurality of stator coils of the stator.

In at least one embodiment, the at least one modular induction rotor includes a first modular induction rotor including a copper induction cage and a second modular induction rotor including an aluminum induction cage.

In at least one embodiment, the at least one modular wound field rotor includes a first modular wound field rotor including separately excited windings that are alternate tooth wound and a second modular wound field rotor including separately excited windings that are all tooth wound.

In at least one embodiment, the at least one modular permanent magnet rotor includes a first modular permanent magnet rotor including high energy magnets, a second modular permanent magnet rotor including low energy magnets, and a third modular permanent magnet rotor including a combination of high energy magnets and low energy magnets.

In at least one embodiment, the at least one modular synchronous reluctance rotor includes a first modular synchronous reluctance rotor including a first flux barrier with three layers of rotor cavities, a second modular synchronous reluctance rotor including a second flux barrier with four layers of rotor cavities, and a third modular synchronous reluctance rotor including a third flux barrier with five layers of rotor cavities.

In at least one embodiment, a variable pole controller electrically coupled to the inverter system, wherein: the variable pole controller is configured to implement pole-phase number modulation to define a first number of stator poles of the stator based on a manipulation of the plurality of switches of the inverter system to generate a first phase shift angle of the AC between adjacent stator coils of the plurality of stator coils of the stator and a second number of stator poles of the stator based on a manipulation of the plurality of switches of the inverter system to generate a second phase shift angle of the AC between the adjacent stator coils of the plurality of stator coils of the stator; the first phase shift angle is less than the second phase shift angle; the first number of stator poles is less that the second number of stator poles; the second number of stator poles is a multiple of the first number of stator poles; a first number of phases of the AC applied to the plurality of stator coils of the stator is based on the first phase shift angle; a second number of phases of the AC applied to the plurality of stator coils of the stator is based on the second phase shift angle; and the first number of phases is a multiple of the second number of phases.

In at least one embodiment, a first product of the first number of stator poles and the first number of phases of the AC applied to the plurality of stator coils is equal to a second product of the second number of stator poles and the second number of phases of the AC applied to the plurality of stator coils.

In at least one embodiment, the stator includes 2 to 4 stator slots per stator pole per phase, with a number of poles changing from 4 or 6 to 8 or 12.

In at least one embodiment, a variable pole controller electrically coupled to the inverter system, wherein: the variable pole controller is configured to implement pole-phase sequence modulation to define a third number of stator poles of the stator based on a manipulation of the plurality of switches of the inverter system to generate a fixed number of phases of the AC applied to the plurality of stator coils of the stator in a first sequence wherein each of the fixed number of phases have a first polarity and to define a fourth number of the stator poles based on a manipulation of the plurality of switches of the inverter system to generate the fixed number of phases of the AC applied to the plurality of stator coils of the stator in a second sequence wherein a first subsequence in the second sequence as the first polarity and a second subsequence in the second sequence has a second polarity that is opposite the first polarity; the third number of stator poles is twice the fourth number of stator poles; and the stator includes seventy-two stator slots, the fourth number of stator poles is six and the third number of stator poles is twelve.

A vehicle includes: one of a front-wheel drive unit, a rear-wheel drive unit, and an all wheel drive rear drive unit, the one of the front-wheel drive unit, the rear-wheel drive unit, and the all wheel drive rear drive unit including a modular variable pole electric motor system including: a stator including a plurality of stator coils; a plurality of modular rotors including at least one modular wound field rotor, at least one modular induction rotor, at least one modular permanent magnet rotor, and at least one modular synchronous reluctance rotor, wherein each of the plurality of modular rotors is configured to be removably electrically coupled to the stator; and an inverter system, wherein the inverter system: includes a plurality of switches; is electrically coupled to the plurality of stator coils of the stator; and is configured to be electrically coupled to a battery system and convert a direct current (DC) voltage from the battery system into alternating current (AC) to individually energize each of the plurality of stator coils of the stator.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle configured to implement a modular variable pole electric motor system in accordance with at least one embodiment;

FIG. 2 is a perspective view of modular variable pole electric motor system in accordance with at least one embodiment;

FIG. 3 is an illustration of an exemplary stator of a modular variable pole electric motor system in accordance with at least one embodiment;

FIG. 4 is functional block diagram of a vehicle including a modular variable pole electric motor system in accordance with at least one embodiment;

FIG. 5 is a functional diagram of an exemplary stator and tables illustrating an exemplary implementation of pole-phase-number modulation in accordance with at least one embodiment; and

FIG. 6 is a functional diagram of an exemplary stator and a table illustrating an exemplary implementation of pole-phase-sequence modulation in accordance with at least one embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

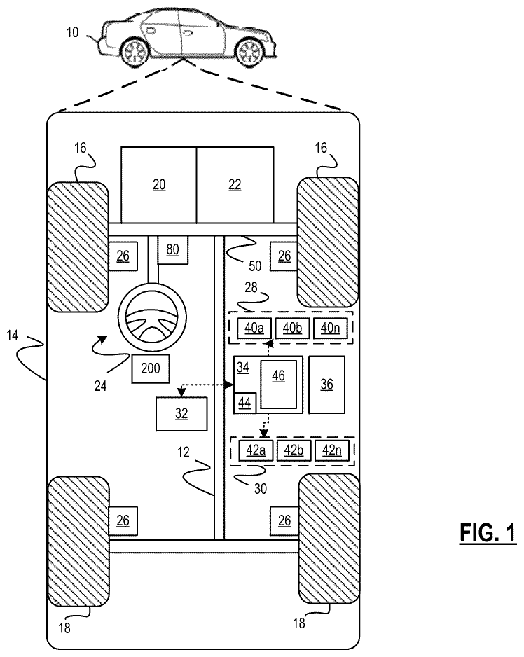

Referring to FIG. 1, a functional block diagram of a vehicle 10 including a modular variable pole electric motor system in accordance with at least one embodiment is shown. The vehicle 10 generally includes a chassis 12, a body 14, front wheels 16, and rear wheels 18. While the vehicle 10 is depicted in the illustrated embodiment as a passenger car, the vehicle 10 may be other types of vehicles including trucks, sport utility vehicles (SUVs), and recreational vehicles (RVs).

In various embodiments, the body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

In various embodiments, the vehicle 10 is an autonomous or semi-autonomous vehicle that is automatically controlled to carry passengers and/or cargo from one place to another. For example, in an exemplary embodiment, the vehicle 10 is a so-called Level Two, Level Three, Level Four or Level Five automation system. Level two automation means the vehicle assists the driver in various driving tasks with driver supervision. Level three automation means the vehicle can take over all driving functions under certain circumstances. All major functions are automated, including braking, steering, and acceleration. At this level, the driver can fully disengage until the vehicle tells the driver otherwise. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the vehicle 10 generally includes a propulsion system 20 a transmission system 22, a steering system 24, a braking system 26, a sensor system 28, an actuator system 30, at least one data storage device 32, at least one controller 34, and a communication system 36. The controller 34 is configured to implement an automated driving system (ADS). The propulsion system 20 is configured to generate power to propel the vehicle. The propulsion system 20 may, in various embodiments, include an electric machine such as a traction motor, a fuel cell propulsion system, and/or any other type of propulsion configuration. In at least one embodiment, the propulsion system 20 includes an electric machine and an internal combustion engine (ICE). In at least one embodiment, the propulsion system 20 includes a modular electric motor. The modular electric motor is a component of the modular variable pole electric motor system.

The transmission system 22 is configured to transmit power from the propulsion system 20 to the vehicle wheels 16, 18 according to selectable speed ratios. According to various embodiments, the transmission system 22 may include a step-ratio automatic transmission, a continuously-variable transmission, or other appropriate transmission. The braking system 26 is configured to provide braking torque to the vehicle wheels 16, 18. The braking system 26 may, in various embodiments, include friction brakes, brake by wire, a regenerative braking system such as an electric machine, and/or other appropriate braking systems.

The steering system 24 is configured to influence a position of the of the vehicle wheels 16. While depicted as including a steering wheel and steering column, for illustrative purposes, in some embodiments contemplated within the scope of the present disclosure, the steering system 24 may not include a steering wheel and/or steering column. The steering system 24 includes a steering column coupled to an axle 50 associated with the front wheels 16 through, for example, a rack and pinion or other mechanism (not shown). Alternatively, the steering system 24 may include a steer by wire system that includes actuators associated with each of the front wheels 16.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, a steering wheel sensor, and/or other sensors.

The vehicle dynamics sensors provide vehicle dynamics data including longitudinal speed, yaw rate, lateral acceleration, longitudinal acceleration, etc. The vehicle dynamics sensors may include wheel sensors that measure information pertaining to one or more wheels of the vehicle 10. In one embodiment, the wheel sensors comprise wheel speed sensors that are coupled to each of the wheels 16, 18 of the vehicle 10. Further, the vehicle dynamics sensors may include one or more accelerometers (provided as part of an Inertial Measurement Unit (IMU)) that measure information pertaining to an acceleration of the vehicle 10. In various embodiments, the accelerometers measure one or more acceleration values for the vehicle 10, including latitudinal and longitudinal acceleration and yaw rate. In at least one embodiment, the vehicle dynamic sensors provide vehicle location and vehicle movement data.

The actuator system 30 includes one or more actuator devices 42a-42n that control one or more vehicle features such as, but not limited to, one or more vehicle wheels 16, 18 the propulsion system 20, the transmission system 22, the steering system 24, and the braking system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities, such as but not limited to, other vehicles (vehicle to vehicle, “V2V” communication,) infrastructure (vehicle to infrastructure “V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in the ADS of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. In at least one embodiment, the vehicle 10, includes a controller 34 that is configured as a variable pole controller.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller(s) 34 are configured to implement ADS.

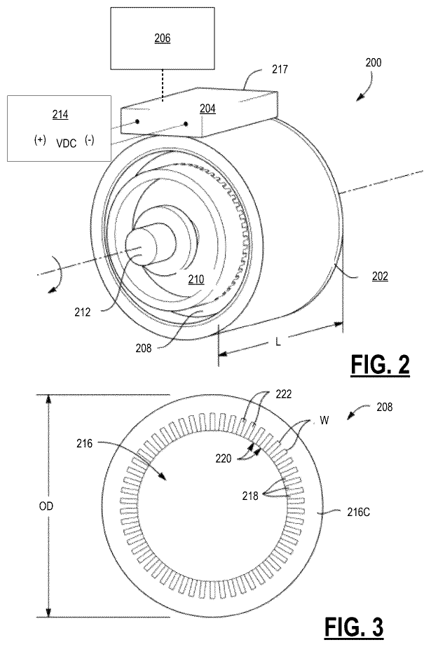

Referring to FIG. 2, a perspective view of a modular variable pole electric motor system 200 in accordance with at least one embodiment is shown. The modular variable pole electric motor system 200 includes a modular electric motor 202, an inverter system 204, and a variable pole controller 206. The modular electric motor 202 includes a stator 208 and a modular rotor 210. The stator 208 includes a plurality of stator coils. The modular electric motor 202 includes a shaft 212. The inverter system 204 is configured to be electrically coupled to a battery system 214 and includes a plurality of switches. The inverter system 204 is electrically coupled to the plurality of stator coils of the stator 208. In at least one embodiment, the inverter system 204 is a traction power inverter module (TPIM). The variable pole controller 206 is electrically coupled to the inverter system 204. The inverter system 204 is configured to convert a direct current (DC) voltage from the battery system 214 into an alternating current (AC) suitable for energizing individual stator coils the plurality of stator coils of the stator 208. In at least one embodiment, the battery system 214 is a multi-cell rechargeable battery pack.

The inverter system 204 and the stator 208 are configured to operate with a plurality of modular rotors 210. The modular rotor 210 is removably coupled to the stator 208. The different modular rotors 210 include, a modular wound field rotor, a modular induction rotor, a modular permanent magnet rotor, and a modular synchronous reluctance rotor. In at least one embodiment, the modular induction rotor includes a copper induction cage. In at least one embodiment, the modular induction rotor includes an aluminum induction cage. In at least one embodiment, the modular wound field rotor with separately excitable windings is alternate stator tooth wound. In at least one embodiment, the modular wound field rotor with separately excitable windings is all stator tooth wound. In at least one embodiment, the modular permanent magnet rotor includes high energy magnets. In at least one embodiment, the modular permanent magnet rotor includes low energy magnets. In at least one embodiment, the modular permanent magnet rotor includes a combination of high energy magnets and low energy magnets. In at least one embodiment, the modular synchronous reluctance rotor has flux barriers and includes three to five layers of rotor cavities

The inverter system 204 and stator 208 can be used across different vehicle platforms with different power specifications with different modular rotors 210. In at least one embodiment, the modular variable pole electric motor system 200 is used in multi-axle vehicles. In at least one embodiment, the modular variable pole electric motor system 200 is integrated into a front-wheel drive unit. In at least one embodiment, the modular variable pole electric motor system 200 is integrated into a rear-wheel drive unit. In at least one embodiment, the modular variable pole electric motor system 200 is integrated into an all wheel drive rear drive unit. Each of the different drive units are associated with different vehicle platforms with different power specifications that are supported by different modular rotors 210.

Referring to FIG. 3, an illustration of an exemplary stator 208 of a modular variable pole electric motor system 200 in accordance with at least one embodiment is shown. The stator 208 includes a center cavity 216 and has an outer diameter OD. The stator 208 includes a plurality of radially projecting stator teeth 218. Adjacent stator teeth 218 are separated from each other by a corresponding stator slot 220. Each stator slot 220 is filled with an electrical conductor 222. In at least one embodiment, the electrical conductors 222 are copper wires. In at least one embodiment, the electrical conductors 222 are copper bars/hairpins. The electrical conductors 222 form stator windings W that define stator coils around a perimeter of the stator 208. When the stator coils are sequentially energized by the inverter system 204, the stator coils individually act as electromagnets. The stator 208 causes the modular rotor 210 to rotate by creating a rotating magnetic field when current is passed through the windings W that define the stator coils of the stator 208.

In at least one embodiment, the variable pole controller 206 is configured to implement pole-phase-number modulation by changing the stator pole number of the stator 208 by changing the phase shift angle of the alternative current (AC) applied to adjacent stator coils of the stator 208. As the number of phases of the AC applied to the stator coils changes, the stator pole number changes. This results in relatively cleaner magnetomotive force (MMF) distribution. The length of the windings W is based on the lowest stator pole count.

In at least one embodiment, the variable pole controller 206 is configured to implement pole-phase-sequence modulation by changing the stator pole number of the stator 208 by changing a polarity and a phase sequence of the AC applied to the adjacent stator coils of the stator 208. While the number of phases remain the same, the stator pole number changes. The use of the same number of phases enables the use of relatively shorter length windings W.

In at least one embodiment, a stator pole-stator slot combination of the stator 208 includes 72 stator slots with six stator poles that are changeable to twelve stator poles. The variable pole controller 206 is configured to manipulate the plurality of switches of the inverter system 204 to enable the operation of the modular electric motor 202 to operate with six stator poles or the twelve stator poles. In at least one embodiment, the stator 208 has four layers with 24 turns per phase with two parallel paths when the modular electric motor 202 is operating with six stator poles and one parallel path when the modular electric motor 202 is operating with the twelve stator poles. Higher stator pole count operation of the modular variable pole electric motor system 200 is typically desirable at lower vehicle speeds to generate higher torque levels. Lower stator pole count operation of the modular variable pole electric motor system 200 is typically desirable at higher vehicle speeds to generate higher power levels and higher efficiency.

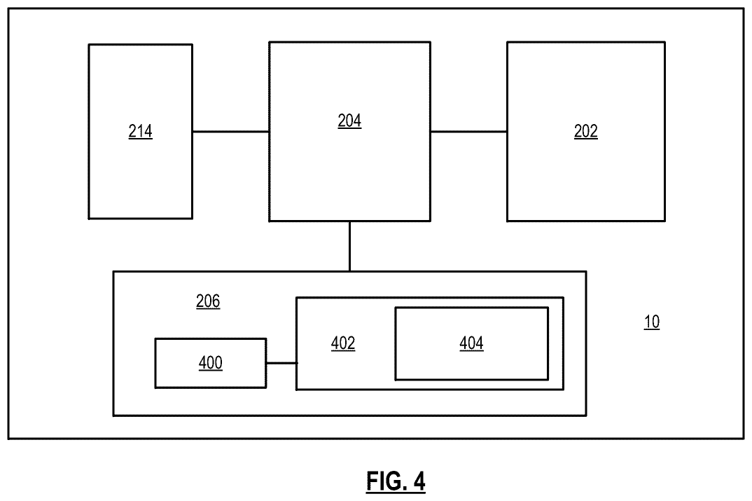

Referring to FIG. 4, a vehicle 10 including a modular variable pole electric motor system 200 in accordance with at least one embodiment is shown. The vehicle 10 includes a modular electric motor 202, an inverter system 204, a variable pole controller 206, and a battery system 214. The variable pole controller 206 includes at least one processor 400 and at least one memory 402. The at least one processor 400 is a programable device that includes one or more instructions stored in or associated with the at least one memory 402. The at least one memory 402 includes instructions that the at least one processor 400 is configured to execute. The at least one memory 402 includes a variable pole management system 406.

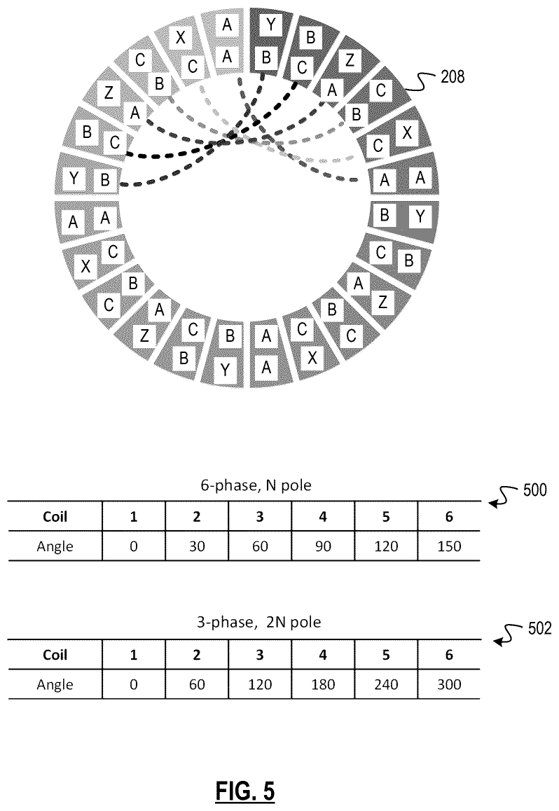

In at least one embodiment, the at least one processor 400 is configured to execute instructions in the variable pole management system 406 to implement pole-phase-number modulation by changing the stator pole number of the stator 208 by changing the phase shift angle of the alternative current (AC) applied to adjacent stator coils of the stator 208 via the inverter system 204. The implementation of pole-phase-number modulation will be described in greater detail below with reference to FIG. 5.

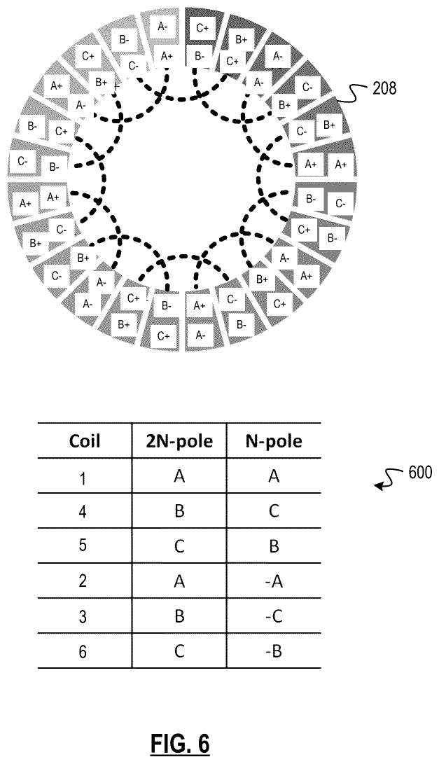

In at least one embodiment, the at least one processor 400 is configured to execute instructions in the variable pole management system 406 to implement pole-phase-sequence modulation by changing the stator pole number of the stator 208 by changing a polarity and a phase sequence of the AC applied to the adjacent stator coils of the stator 208. The implementation of pole-phase-sequence modulation will be described in greater detail below with reference to FIG. 6.

Referring to FIG. 5, a functional diagram of an exemplary stator 208 and tables 500, 502 illustrating an exemplary implementation of pole-phase-number modulation in accordance with at least one embodiment is shown. The stator 208 includes a plurality of stator coils. The variable pole controller 206 is configured to implement pole-phase number modulation to define a number of stator poles of the stator 208 based on a manipulation of a plurality of switches of an inverter system 204 to generate a phase shift angle of an AC between adjacent stator coils of the plurality of stator coils of the stator 208. The number of phases of the AC applied to the plurality of stator coils is based on the phase shift angle. The variable pole controller 206 is configured to vary the phase shift angle of the AC between adjacent stator coils of the plurality of stator coils to vary the number of stator poles via the inverter system 204.

The exemplary stator 208 includes six stator coils. When the variable pole controller 206 generates a first phase shift angle of 30° of the AC for application to the six stator coils via the inverter system 204, the inverter system 204 generates six phases A, B, C, X, Y, Z of the AC and defines N stator poles. For example, referring to the first table 500, at a moment in time, a first phase A of the AC having a phase angle of 0° is applied to the first stator coil, a second phase X of the AC having a phase angle of 30° is applied to the second stator coil, a third phase C of the AC having a phase angle of 60° is applied to the third stator coil, a fourth phase Z of the AC having a phase angle of 90° is applied to the fourth stator coil, a fifth phase B of the AC having a phase angle of 120° is applied to the fifth stator coil, and a sixth phase Y of the AC having a phase angle of 150° is applied to the sixth stator coil.

When the variable pole controller 206 generates a second phase shift angle of 60° of the AC for application to the six stator coils via the inverter system 204, the inverter system 204 generates three phases A, B, C of the AC and defines 2N stator poles. For example, referring to the second table 502, at a moment in time, a first phase A of the AC having a phase angle of 0° is applied to the first stator coil, a second phase C of the AC having a phase angle of 60° is applied to the second stator coil, a third phase B of the AC having a phase angle of 120° is applied to the third stator coil, the first phase A of the AC having a phase angle of 180° is applied to the fourth stator coil, the second phase C of the AC having a phase angle of 240° is applied to the fifth stator coil, and the third phase B of the AC having a phase angle of 150° is applied to the sixth stator coil.

In this example, the first phase shift angle 30° is less than the second phase shift angle 60° The first number of stator poles associated with the first phase shift angle 30° is N and the second number of stator poles associated with the second phase shift angle 60° is 2N. The first number of stator poles N is less than the second number of stator poles 2N. The second number of stator poles 2N is a multiple of the first number of stator poles N. A first number of phases, the six phases A, B, C, X, Y, Z of the AC applied to the six stator coils is based on the phase shift angle of 30°. A second number of phases, the three phases A, B, C of the AC applied to the six stator coils is based on the phase shift angle of 60°. A product of the first number of stator poles (N) and the first number of phases (six) associated with the phase shift angle of 30° is equal to a product of the second number of stator poles (2N) and the second number of phases (three) associated with the phase shift angle of 60°.

In alternative embodiments, the number of stator poles may be a different multiple of the first number of stator poles N resulting from the application of a different number of phases of the AC in accordance with an associated phase shift angle.

FIG. 6, a functional diagram of an exemplary stator 208 and a table 600 illustrating an exemplary implementation of pole-phase-sequence modulation in accordance with at least one embodiment is shown. The stator 208 includes a plurality of stator coils. The variable pole controller 206 is configured to implement pole-phase sequence modulation to define a number of stator poles of the stator 208 based on a manipulation of the plurality of switches of the inverter system 204 to generate a number of phases of the AC for application to the plurality of stator coils of the stator 208 in a specific sequence with specific polarities associated with each of the phases of the AC in the specific sequence. The variable pole controller 206 is configured to change the number of stator poles of the stator 208 by changing the sequence and the polarities of the phases of the AC. The number of phases of the AC does not change when the stator pole number changes.

The exemplary stator 208 includes six stator coils. When the variable pole controller 206 generates three phase A, B, C of the AC for the application to the six stator coils in a first sequence where each of the three phases A, B, C have a specific polarity via the inverter system 204, a first number of stator poles 2N is generated. For example, referring to table 600, at a moment in time, a first phase A of the AC having a positive polarity is applied to the first stator coil, a second phase B of the AC having a positive polarity is applied to the fourth stator coil, a third phase C of the AC having a positive polarity is applied to the fifth stator coil, the first phase A of the AC having a positive polarity is applied to the second stator coil, the second phase B of the AC having a positive polarity is applied to the third stator coil, and a third phase C of the AC have a positive polarity is applied to the sixth stator coil.

When the variable pole controller 206 generates the three phase A, B, C of the AC for the application to the six stator coils in a second sequence where each of the three phases A, B, C have a specific polarity via the inverter system 204, a second number of stator poles N is generated. For example, referring to table 600, at a moment in time, a first phase A of the AC having a positive polarity is applied to the first stator coil, a third phase C of the AC having a positive polarity is applied to the fourth stator coil, a second phase B of the AC having a positive polarity is applied to the fifth stator coil, the first phase A of the AC having a negative polarity is applied to the second stator coil, the third phase C of the AC having a negative polarity is applied to the third stator coil, and a second phase B of the AC have a negative polarity is applied to the sixth stator coil.

The number of phases (three phases) remains the same in both cases. The sequence of the three phases A, B, C the AC applied to the six stator coils changes and the polarity of some of the phase changes. The number of stator poles 2N in the first sequence is twice the number of stator poles N in the second sequence. In alternative embodiments, a different number of phases, which remain the same in both cases, may be used to generate the stator poles. In at least one embodiment, the stator includes 2 to 4 stator slots per stator pole per phase, with a number of poles changing from 4 or 6 to 8 or 12. In at least one embodiment,

In at least one embodiment, the plurality of modular rotors 210 includes modular wound field rotors, modular induction rotors, modular permanent magnet rotors, and modular synchronous reluctance rotors that have different numbers of rotor poles. The modular rotor 210 that is selected for use with the stator 208 has a number of rotor poles that is equal to the generated number of stator poles of the stator 208.

A first stator pole count is desirable for peak low-speed torque applications and a second stator pole count is desirable for peak power or high speed torque applications in a vehicle 10, where the first stator pole count is higher than the second stator pole count. The second lower stator pole count is desirable for maximum efficiency at high speed applications in a vehicle 10.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A modular variable pole electric motor system comprising:
a stator comprising a plurality of stator coils;
a plurality of modular rotors comprising at least one modular wound field rotor, at least one modular induction rotor, at least one modular permanent magnet rotor, and at least one modular synchronous reluctance rotor, wherein each of the plurality of modular rotors is configured to be removably electrically coupled to the stator; and
an inverter system, wherein the inverter system:
comprises a plurality of switches;
is electrically coupled to the plurality of stator coils of the stator; and
is configured to be electrically coupled to a battery system and convert a direct current (DC) voltage from the battery system into alternating current (AC) to individually energize each of the plurality of stator coils of the stator.

2. The system of claim 1, wherein the at least one modular induction rotor comprises a first modular induction rotor including a copper induction cage and a second modular induction rotor including an aluminum induction cage.

3. The system of claim 1, wherein the at least one modular wound field rotor comprises a first modular wound field rotor including separately excited windings that are alternate tooth wound and a second modular wound field rotor including separately excited windings that are all tooth wound.

4. The system of claim 1, wherein the at least one modular permanent magnet rotor comprises a first modular permanent magnet rotor including high energy magnets, a second modular permanent magnet rotor including low energy magnets, and a third modular permanent magnet rotor including a combination of high energy magnets and low energy magnets.

5. The system of claim 1, wherein the at least one modular synchronous reluctance rotor comprises a first modular synchronous reluctance rotor including a first flux barrier with three layers of rotor cavities, a second modular synchronous reluctance rotor including a second flux barrier with four layers of rotor cavities, and a third modular synchronous reluctance rotor including a third flux barrier with five layers of rotor cavities.

6. The system of claim 1, further comprising a variable pole controller electrically coupled to the inverter system, wherein:
the variable pole controller is configured to implement pole-phase number modulation to define a first number of stator poles of the stator based on a manipulation of the plurality of switches of the inverter system to generate a first phase shift angle of the AC between adjacent stator coils of the plurality of stator coils of the stator and a second number of stator poles of the stator based on a manipulation of the plurality of switches of the inverter system to generate a second phase shift angle of the AC between the adjacent stator coils of the plurality of stator coils of the stator;
the first phase shift angle is less than the second phase shift angle;
the first number of stator poles is less that the second number of stator poles;
the second number of stator poles is a multiple of the first number of stator poles;
a first number of phases of the AC applied to the plurality of stator coils of the stator is based on the first phase shift angle;
a second number of phases of the AC applied to the plurality of stator coils of the stator is based on the second phase shift angle; and
the first number of phases is a multiple of the second number of phases.

7. The system of claim 6, wherein a first product of the first number of stator poles and the first number of phases of the AC applied to the plurality of stator coils is equal to a second product of the second number of stator poles and the second number of phases of the AC applied to the plurality of stator coils.

8. The system of claim 6, wherein the stator includes 2 to 4 stator slots per stator pole per phase, with a number of poles changing from 4 or 6 to 8 or 12.

9. The system of claim 1, further comprising a variable pole controller electrically coupled to the inverter system, wherein:
the variable pole controller is configured to implement pole-phase sequence modulation to define a third number of stator poles of the stator based on a manipulation of the plurality of switches of the inverter system to generate a fixed number of phases of the AC applied to the plurality of stator coils of the stator in a first sequence wherein each of the fixed number of phases have a first polarity and to define a fourth number of the stator poles based on a manipulation of the plurality of switches of the inverter system to generate the fixed number of phases of the AC applied to the plurality of stator coils of the stator in a second sequence wherein a first subsequence in the second sequence as the first polarity and a second subsequence in the second sequence has a second polarity that is opposite the first polarity; and
the third number of stator poles is twice the fourth number of stator poles.

10. The system of claim 9, wherein the stator includes 2 to 4 stator slots per stator pole per phase, with a number of poles changing from 4 or 6 to 8 or 12.

11. A vehicle including a modular variable pole electric motor system comprising:
a stator comprising a plurality of stator coils;
a plurality of modular rotors comprising at least one modular wound field rotor, at least one modular induction rotor, at least one modular permanent magnet rotor, and at least one modular synchronous reluctance rotor, wherein each of the plurality of modular rotors is configured to be removably electrically coupled to the stator; and
an inverter system, wherein the inverter system:
comprises a plurality of switches;
is electrically coupled to the plurality of stator coils of the stator; and
is configured to be electrically coupled to a battery system and convert a direct current (DC) voltage from the battery system into alternating current (AC) to individually energize each of the plurality of stator coils of the stator.

12. The vehicle of claim 11, wherein the at least one modular induction rotor comprises a first modular induction rotor including a copper induction cage and a second modular induction rotor including an aluminum induction cage.

13. The vehicle of claim 11, wherein the at least one modular wound field rotor comprises a first modular wound field rotor including separately excited windings that are alternate tooth wound and a second modular wound field rotor including separately excited windings that are all tooth wound.

14. The vehicle of claim 11, wherein the at least one modular permanent magnet rotor comprises a first modular permanent magnet rotor including high energy magnets, a second modular permanent magnet rotor including low energy magnets, and a third modular permanent magnet rotor including a combination of high energy magnets and low energy magnets.

15. The vehicle of claim 11, wherein the at least one modular synchronous reluctance rotor comprises a first modular synchronous reluctance rotor including a first flux barrier with three layers of rotor cavities, a second modular synchronous reluctance rotor including a second flux barrier with four layers of rotor cavities, and a third modular synchronous reluctance rotor including a third flux barrier with five layers of rotor cavities.

16. The vehicle of claim 11, further comprising a variable pole controller electrically coupled to the inverter system, wherein:
the variable pole controller is configured to implement pole-phase number modulation to define a first number of stator poles of the stator based on a manipulation of the plurality of switches of the inverter system to generate a first phase shift angle of the AC between adjacent stator coils of the plurality of stator coils of the stator and a second number of stator poles of the stator based on a manipulation of the plurality of switches of the inverter system to generate a second phase shift angle of the AC between the adjacent stator coils of the plurality of stator coils of the stator;
the first phase shift angle is less than the second phase shift angle;
the first number of stator poles is less that the second number of stator poles;
the second number of stator poles is a multiple of the first number of stator poles;
a first number of phases of the AC applied to the plurality of stator coils of the stator is based on the first phase shift angle;
a second number of phases of the AC applied to the plurality of stator coils of the stator is based on the second phase shift angle; and
the first number of phases is a multiple of the second number of phases.

17. The vehicle of claim 16, wherein a first product of the first number of stator poles and the first number of phases of the AC applied to the plurality of stator coils is equal to a second product of the second number of stator poles and the second number of phases of the AC applied to the plurality of stator coils.

18. The vehicle of claim 16, wherein the stator includes 2 to 4 stator slots per stator pole per phase, with a number of poles changing from 4 or 6 to 8 or 12.

19. The vehicle of claim 11, further comprising a variable pole controller electrically coupled to the inverter system, wherein:
the variable pole controller is configured to implement pole-phase sequence modulation to define a third number of stator poles of the stator based on a manipulation of the plurality of switches of the inverter system to generate a fixed number of phases of the AC applied to the plurality of stator coils of the stator in a first sequence wherein each of the fixed number of phases have a first polarity and to define a fourth number of the stator poles based on a manipulation of the plurality of switches of the inverter system to generate the fixed number of phases of the AC applied to the plurality of stator coils of the stator in a second sequence wherein a first subsequence in the second sequence as the first polarity and a second subsequence in the second sequence has a second polarity that is opposite the first polarity;
the third number of stator poles is twice the fourth number of stator poles; and
the stator includes seventy-two stator slots, the fourth number of stator poles is six and the third number of stator poles is twelve.

20. A vehicle comprising:
one of a front-wheel drive unit, a rear-wheel drive unit, and an all wheel drive rear drive unit, the one of the front-wheel drive unit, the rear-wheel drive unit, and the all wheel drive rear drive unit including a modular variable pole electric motor system comprising:
a stator comprising a plurality of stator coils;
a plurality of modular rotors comprising at least one modular wound field rotor, at least one modular induction rotor, at least one modular permanent magnet rotor, and at least one modular synchronous reluctance rotor, wherein each of the plurality of modular rotors is configured to be removably electrically coupled to the stator; and
an inverter system, wherein the inverter system:
comprises a plurality of switches;
is electrically coupled to the plurality of stator coils of the stator; and
is configured to be electrically coupled to a battery system and convert a direct current (DC) voltage from the battery system into alternating current (AC) to individually energize each of the plurality of stator coils of the stator.
